(19) United States
(12) Patent Application Publication
(10) Pub. No.: US 2017/0205820 A1
(43) Pub. Date: Jul. 20, 2017

(54) UNMANNED AERIAL VEHICLE POWERED TRANSPORTATION

(71) Applicant: Tong Liu, Encino, CA (US)

(72) Inventor: Tong Liu, Encino, CA (US)

(21) Appl. No.: 15/353,713

(22) Filed: Nov. 16, 2016

Related U.S. Application Data
(60) Provisional application No. 62/280,516, filed on Jan. 19, 2016.

(51) Int. Cl. G05D 1/00; G05D 1/08; B64C 39/02

(52) U.S. Cl. CPC G05D 1/0016; B64C 39/024; G05D 1/0033; G05D 1/0808; B64C 39/022; B64C 2201/146; B64C 2201/12; A63C 17/011

(57) ABSTRACT

A transportation tool is configured to carry a rider. A sensor detects weight shifts of the rider on the body of the transportation tool. A controller, based on information from the sensor, generates control signals for an unmanned aerial vehicle. A communication device communicates the control signals to the unmanned aerial vehicle. A cable attaches to the aerial vehicle and to the rider or the body of the transportation tool.

### BACKGROUND

Transportation options in large crowded cities like Los Angeles, San Francisco, New York, have typically included, automobiles, motorcycles, scooters, trains, buses, underground transit systems and so on. In addition to powered transportation, there are non-powered alternatives such as bicycles, tricycles, unicycles, skateboards, roller skates and so on. More recently, newly developed powered transportation tools have included powered skates, powered skateboards and self-balancing single wheel and dual wheel vehicles.

### BRIEF DESCRIPTION OF THE DRAWINGS

FIG. 1 illustrates an unmanned aerial vehicle (UAV) powered transportation device in accordance with an implementation.

FIG. 2 is a simplified block diagram of a digital controller for the UAV powered transportation device shown in FIG. 1 in accordance with an implementation.

FIG. 3 is a simplified block diagram of a digital controller that controls turning of the UAV powered transportation device shown in FIG. 1 in accordance with an implementation.

FIG. 4 shows an underside of a skateboard modified for use with the UAV powered transportation device shown in FIG. 1 in accordance with an implementation.

FIG. 5 shows a topside of the skateboard shown in FIG. 4 in accordance with another implementation.

FIG. 6 shows an underside of a skateboard modified for use with the UAV powered transportation device shown in FIG. 1 in accordance with another implementation.

FIG. 7 shows a simplified control block diagram for control circuity mounted on a skateboard modified for use with the UAV powered transportation device in accordance with an implementation.

FIG. 8 and FIG. 9 show a hoverboard modified for use with the UAV powered transportation device in accordance with an implementation

FIG. 10 shows a UAV used to provide power for skiing in accordance with an implementation.

FIG. 11 shows a UAV used to provide power for wakeboarding in accordance with an implementation.

FIG. 12 shows a UAV used to provide power for surfing in accordance with an implementation.

FIG. 13 and FIG. 14 illustrate using a spring scale to calibrate UAV powered transportation device in accordance with an implementation.

### DESCRIPTION OF THE EMBODIMENT

A UAV is used to provide power to a transportation tool. Transportation tools for which a UAV may provide power include, for example, skateboards, skates, hoverboards, snow skis, snowboards, water skis, wakeboards, surf boards and so on.

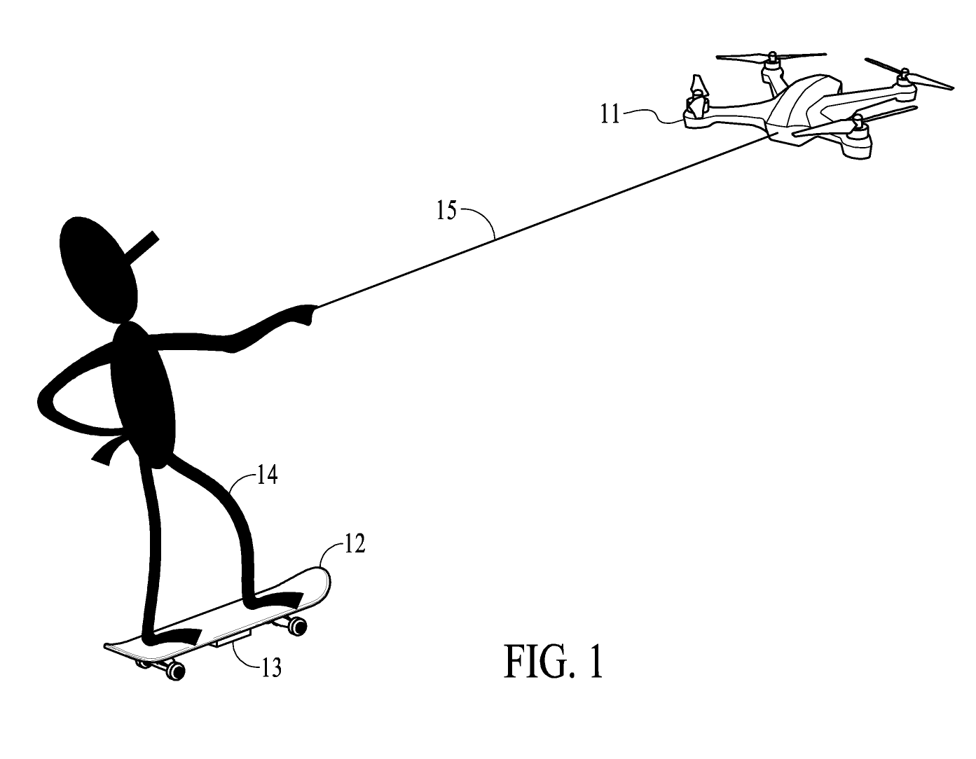

FIG. 1 shows an unmanned aerial vehicle (UAV) powered transportation device that includes a UAV 11, a modified skateboard 12, a control device 13 and a cable 15. For example, cable 15 is two to six feet long and is connected via a hook to UAV 11. Other cable lengths also can be used. Cable 15 is composed of, for example, rope, chain, wire cable or some other type of cable.

UAV 11 provides power to transport a rider 14 on skateboard 12. Control device 13 monitors weight shift of rider 14 on skateboard 12 to provide control signals to UAV 11. Control device provides four types of control information to UAV 11. These four types of control information pertain to acceleration, deceleration, left turn and right turn. Control device 13 provides the control information wirelessly to UAV 11, for example, using the Bluetooth protocol, a WiFi protocol or some other wireless protocol. Alternatively, control device provides control information to UAV 11 through a wire connection.

Within control device 13, weight distribution of rider 14 on skateboard 12 is monitored to determine whether to signal control device 13 to accelerate, decelerate, veer right or veer left. For example, control device 13 signals UAV to accelerate as rider 14 shifts weight back on skateboard 12. Control device 13 signals UAV 11 to decelerate as rider 14 shifts weight forward on skateboard 12. Control device 13 signals UAV 11 to veer right as rider 14 shifts weight right on skateboard 12. Control device 13 signals UAV 11 to veer left as rider 14 shifts weight left on skateboard 12. When weight is removed from skateboard 12, control device signals UAV 11 to hover.

Cable 15 includes, for example, a handle that rider 14 can use to hold on to cable 15. Alternatively, cable 15 can be attached directly to rider 14, for example to the waist or belt of rider 14. Alternatively, cable 15 can be attached directly to skateboard 13. When cable 15 is attached directly to skateboard 13, control device 13 signals UAV to accelerate as rider 14 shifts weight forward on skateboard 12 and control device 13 signals UAV 11 to decelerate as rider 14 shifts weight back on skateboard 12.

Safety mechanisms are included, for example, to safeguard rider 14. For example, upon reaching an undesired speed UAV 11 can be freed, for example, by rider 14 letting go of a handle of cable 15, or by use of a quick release releasing cable 15 from attachment to example rider 14 or skateboard 13. Further any time weight is removed from skateboard 13, for example by rider 14 stepping off skateboard 13, UAV 11 stops forward motion and hovers at a safe distance above the head of rider 14. Further, UAV 11 can have a speed guard that prevents UAV 11 from going faster than a predetermined maximum speed. In addition, a video camera installed in UAV 11 can be used to monitor rider 14. Any detected mishap will result in UAV 11 stopping forward motion and hovering at a safe distance above the head of rider 14. Further, the video camera can be monitored by a third party to oversee safety of rider 14. Further, a sudden drop in speed of skateboard 13, for example caused by a road obstacle, will result in commands to UAV 11 to decelerate appropriately before resuming speed. For example, similar safety mechanisms can be incorporated in all the transportation tools discussed herein.

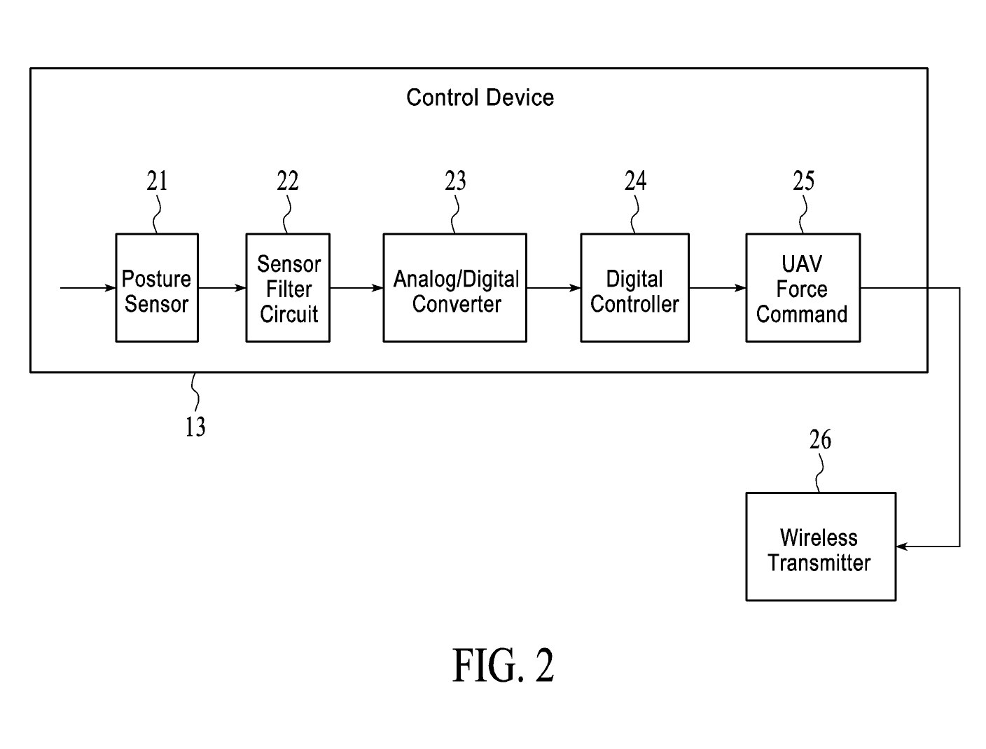

FIG. 2 is a simplified block diagram of logic blocks within control device 13 that generate acceleration and deceleration information for signaling UAV 11. A posture sensor 21 determines whether weight of rider 14 on skateboard 12 is being shifted forward or back. An analog signal containing current weight shift is received by a sensor filter circuit 22 that filters out noise in order to help ascertain the intention of rider to consciously shift weight forward or backwards on skateboard 12. This filtering can filter out the slight shifts in weight that are necessary for rider 14 to stay balanced on skateboard 12.

An analog/digital converter 23 receives the filtered analog signal from sensor filter circuit 22 and generates a digital signal. A digital controller 24 receives the digital signal and generates a UAV force command on an output 25. Wireless transmitter 26 forwards the UAV force command to UAV 11. Based on the value of the UAV force command, UAV 11 either accelerates, decelerates or maintains a current speed.

For example, digital controller 24 is implemented by a microprocessor. The UAV force commands are generated based on estimated posture of rider 14. For example, a neutral posture is translated as maintaining current speed. A three degree lean backwards may be translated as a command to double current pulling force. A leaning forward of two degrees may signal braking by reducing force. The greater the lean forward the faster the speed is reduced until the UAV is merely hovering. As discussed above, when cable 15 is attached directly to skateboard 13, control device 13 signals UAV to accelerate as rider 14 shifts weight forward on skateboard 12 and control device 13 signals UAV 11 to decelerate as rider 14 shifts weight back on skateboard 12.

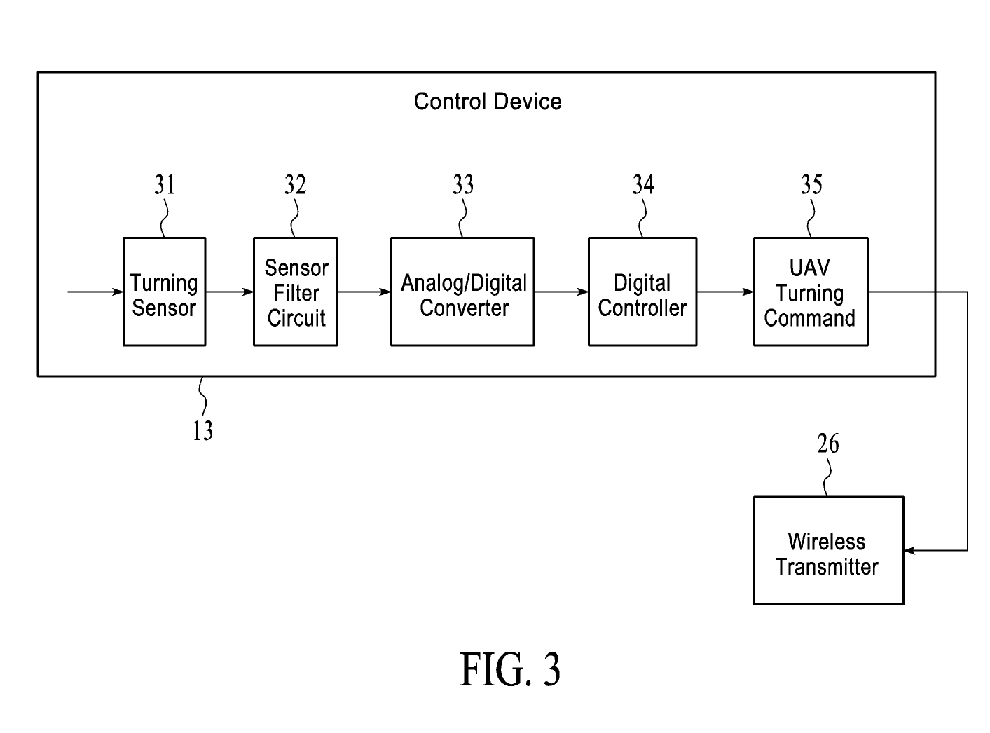

FIG. 3 is a simplified block diagram of logic blocks within digital controller that generate left turn and right turn information for signaling UAV 11. The logic blocks shown in FIG. 3 may be integrated with the logic blocks shown in FIG. 2, or may be implemented separately as illustrated in FIG. 3.

A posture sensor 31 determines whether weight of rider 14 on skateboard 12 is being shifted left or right. An analog signal containing current weight shift is received by a sensor filter circuit 32 that filters out noise in order to help ascertain the intention of rider 14 to consciously shift weight left or right on skateboard 12. This filtering can filter out the slight shifts in weight that are necessary for rider 14 to stay balanced on skateboard 12.

An analog/digital converter 33 receives the filtered analog signal from sensor filter circuit 32 and generates a digital signal. A digital controller 34 receives the digital signal and generates a UAV turning command on an output 35. Wireless transmitter 26 forwards the UAV turning command to UAV 11. Based on the value of the UAV turning command, UAV 11 either veers right, veers left or maintains a current direction.

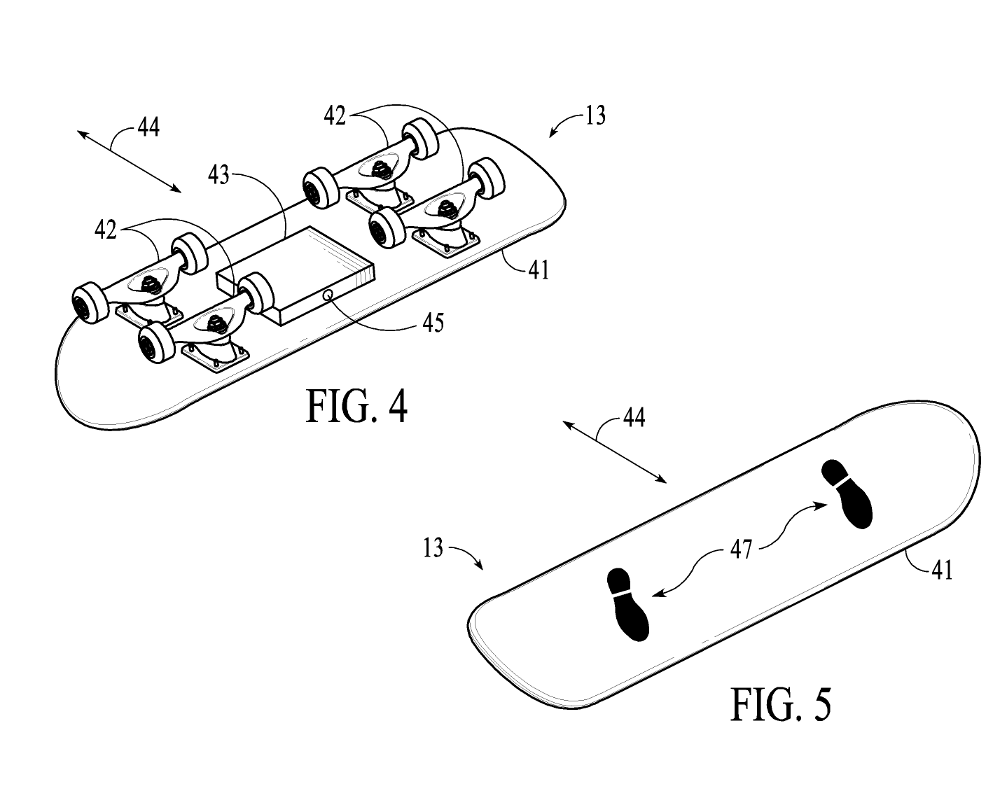

FIG. 4 shows an underside of skateboard 13. As seen from FIG. 4, skateboard 13 has been modified from a typical skateboard configuration. Relative direction of travel of skateboard 13 is illustrated by an arrow 44. Relative direction of travel of skateboard 13 is 90 degree rotated from the relative direction of travel of a typical skateboard. To accommodate the relative direction of travel of skateboard 13, wheel assemblies 42 of skateboard 13 are mounted of a body 41 of skateboard 13 as shown. Housing 43 is mounted on body 41 of skateboard 13. Housing 43 houses control device 13, wireless transmitter 26 and any other circuitry associated with skateboard 13.

A system power-on button 45 is also located on housing 43. A system power-on button 45 is also located on housing 43.

System power on is implemented by both a smart phone application and a physical power-on button 45 located on housing 43. In the smart phone application, a rider can push a screen button in the smart phone to start the power on the skateboard electrical circuit and UAV to power on and get ready. In the smart phone application, the rider can push another screen button in smart phone to stop the power on the skateboard electrical circuit and UAV and disengage. For example, the smart phone application shows the percentage power remaining for the battery in skateboard. For example, the rider can also push power-on button 45 for more than 3 seconds to power on and get ready. The rider can push power-on button 45 for more than 3 seconds to power off and get disengage

For example, posture sensor 21 and posture sensor 31 can be implanted by a spring loaded linear potential meter, or by a strain gauge. For example, when a spring loaded linear potential meter is used, one end of a spring loaded linear potential meter is attached to one of wheel assemblies 42 and the other is attached to body 41. Weight distribution on body 41 will affect the tension on the spring within spring loaded linear potential meter, providing a reading that will allow weight distribution to be monitored. For example, four spring loaded linear potential meters can be used, one connected to each of the four wheel assemblies 42.

For example, when a strain gauge is used, the strain gauge is attached directly to a vertical support pole of assemblies 42. Weight distribution on body 41 will affect strain on body 41 which will be detected by the strain gauge. The four force sensor reading are used to calculate the center of gravity, which gives the command information to turn left, turn right, accelerate or decelerate. For example, four instantaneous force readings allow calculation of the location of the center of gravity Fc. For example, given four instantaneous force readings (F1,F2,F3,F4), the x and y coordinates for the center of gravity can be calculated. The value for the X coordinate is obtained by X=(F3+F4−F1−F2)*a/(F1+F2+F3+F4) where “a” equals a length in the X direction. The value for the Y coordinate is obtained by Y=(F1+F3−F2−F4)*b/(F1+F2+F3+F4) where “b” equals a length in the Y direction.

For applications below where a transportation has no wheels (e.g., for a surf board, a wake board, snow skis etc.) use of a strain gauge is a preferred method for detecting weight distribution.

Whether using a spring loaded linear potential meter or a strain gauge, the readings are used to determine shifts in the center of gravity on body 41. The direction and the degree of shifts are used to provide information about acceleration, deceleration, left turn and right turn.

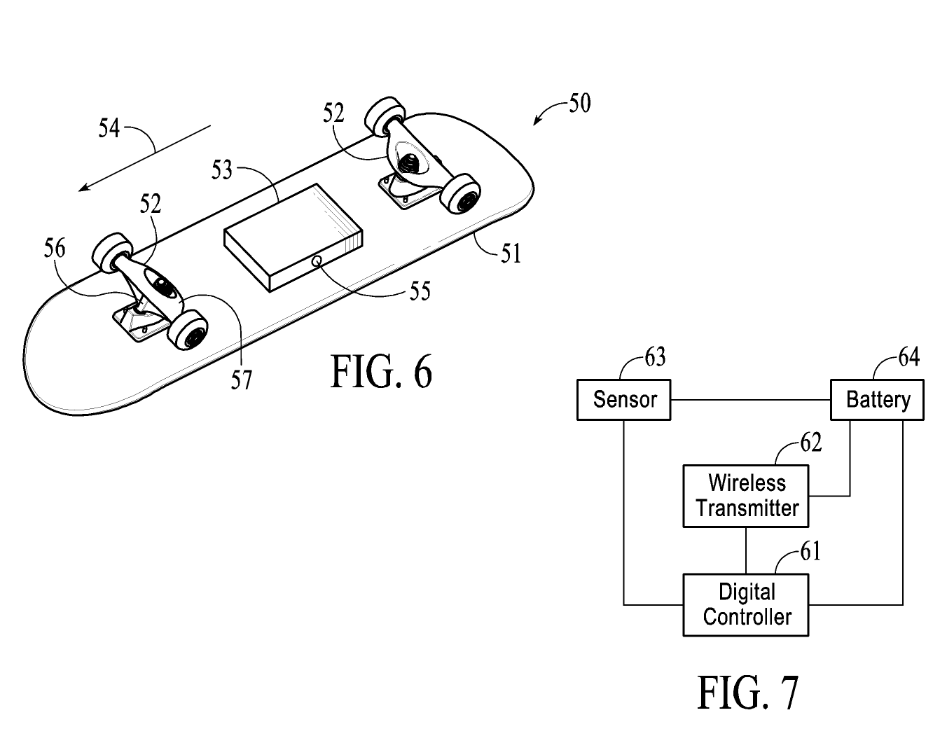

FIG. 5 shows a top side of skateboard 13. Footprints 47 indicate approximate locations for feet of rider 14 on body 41 of skateboard 13 as rider 14 travels in moving direction 44.

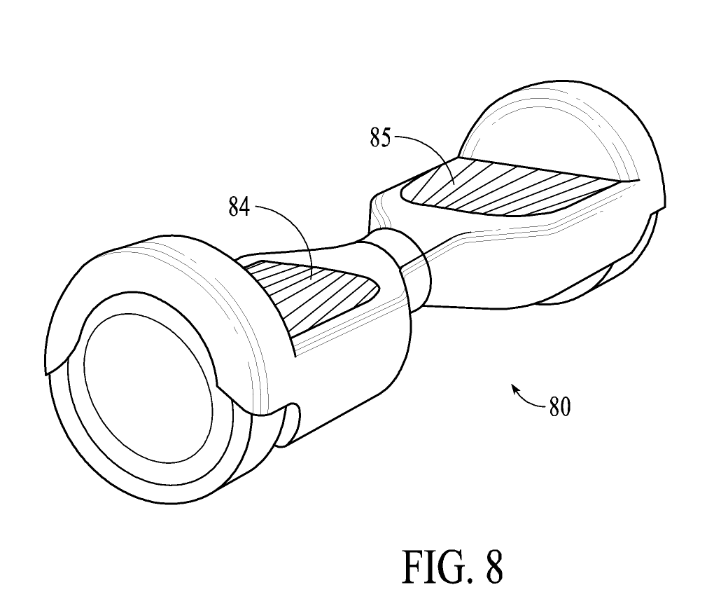

FIG. 6 shows an alternative implementation of a skateboard 50 that has a conventional skateboard configuration where relative direction of travel is illustrated by an arrow 54. To accommodate the relative direction of travel, wheels 52 of skateboard 50 are mounted of a body 51 of skateboard 50 as shown. Housing 53 is mounted on body 51 of skateboard 50. Housing 53 houses circuitry associated with skateboard 50. A system power-on button 55 is located on housing 53. A strain gauge can be added at vertical pole 56 is discussed above. A spring also exists at the location of vertical pole 56. Once piece horizontal part 57 is attached to the wheels of the skateboard.

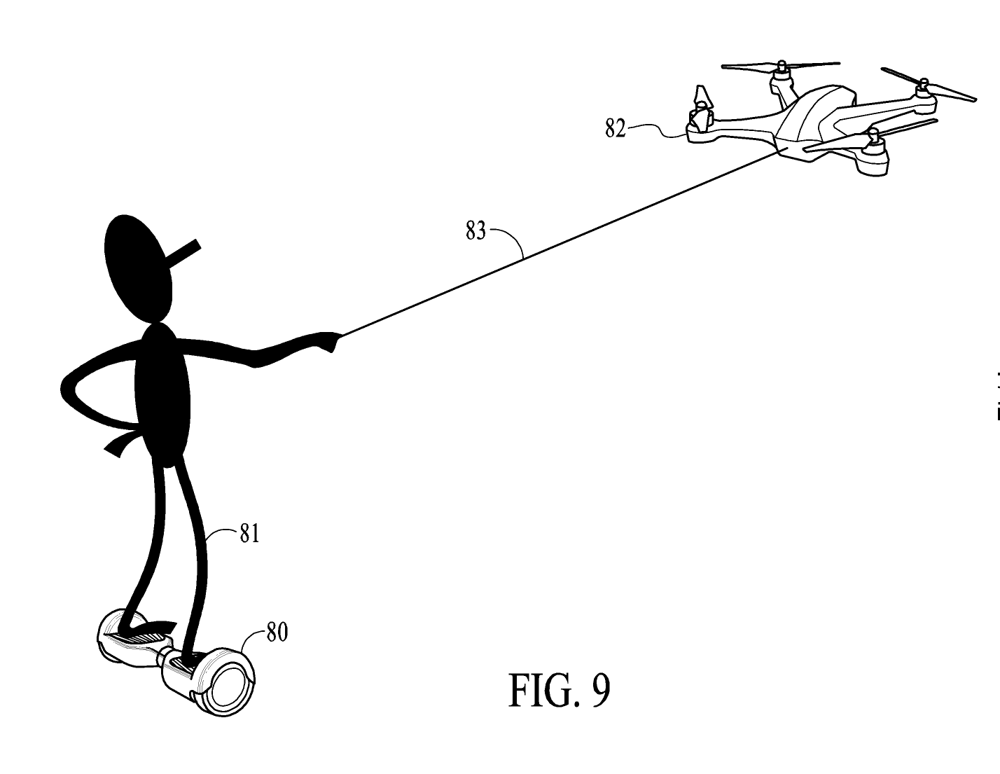

FIG. 7 shows an example of circuitry within housing 53. A sensor 63 senses weight shifts of a rider of skateboard 50 who is riding on body 51. A digital controller 61 receives signals from sensor 63 and generates command information for UAV 11. A wireless transmitter 62 forwards the command information to UAV 11. For example, the command information includes command information to accelerate, decelerate, veer left, veer right or hover. A battery 64 provides power to sensor 63, digital controller 61 and wireless transmitter 62.

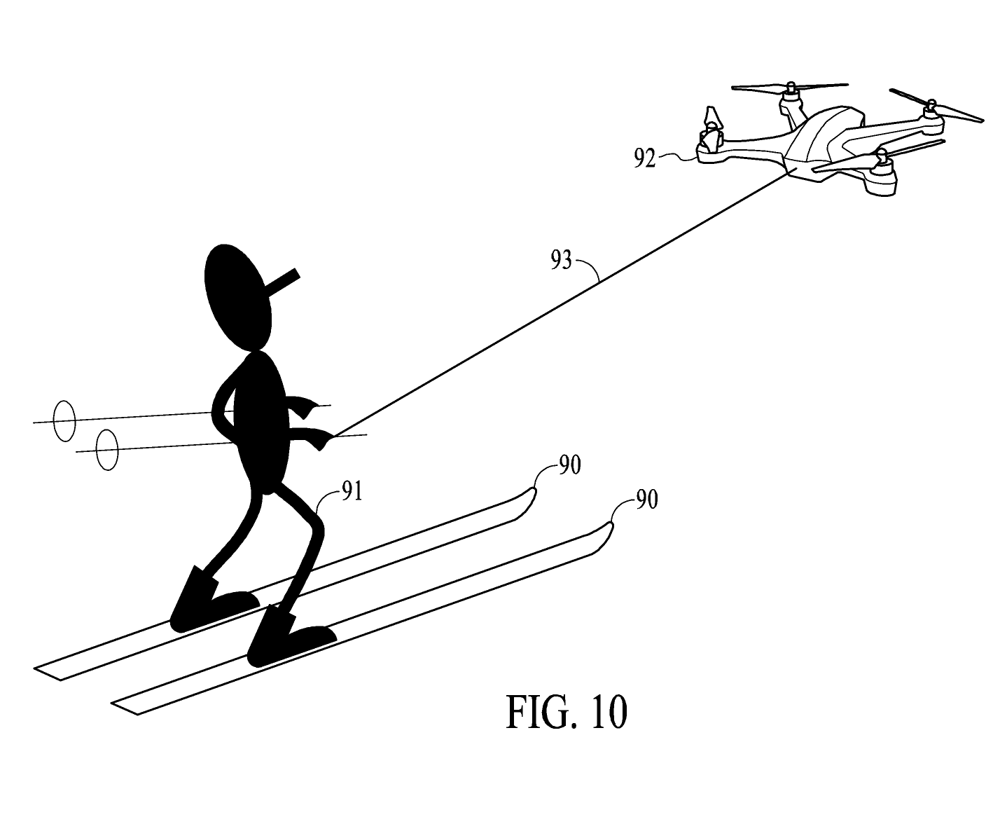

Using the same principles which allow a UAV to power movement on a skateboard, a UAV can power transportation on other devices. For example, FIG. 8 and FIG. 9 show a hoverboard 80 adapted to be used with a UAV 82. A cable 83 is composed of, for example, rope, chain, wire cable or some other type of cable. For example, cable 83 is two to six feet long and is connected via a hook to UAV 82.

UAV 82 provides power to transport a rider 81 on hoverboard 80. A control device within hoverboard 80 monitors weight shift of rider 81 on hoverboard 80 to provide control signals to UAV 82. The control device provides UAV 83 with control information pertaining to acceleration, deceleration, left turn and right turn. The control information is provided wirelessly to UAV 82, for example, using the Bluetooth protocol, a WiFi protocol or some other wireless protocol.

Hover board 80 is modified to act differently than a normal hover board. Rider 81 leans backward and forward on hove board structure 80 to accelerate and decelerate. In prior art hoverboards, such leaning signals are sent to a motor in a wheel to accelerate and decelerate. The control circuitry in hoverboard 80, however, sends accelerate and decelerate signals to UAV 82, these signals are sent to UAV 82 to control speed of rider 81 on hoverboard 80.

Relative orientation of side 84 to side 85 of hoverboard 80 are be adjusted by the feet of rider 80 to control direction. While in prior art hoverboards, control signals resulting from relative orientation of different sides are used to generate turning signals sent to motors in the wheels of hoverboard to control turning, in hoverboard 80 control signals resulting from relative orientation of side 84 and side 85 are used to generate turning signals sent to UAV 82 to control turning.

For example, an electrical motor in the wheels of hoverboard 80 can still be used to maintain the system balance; however, power for acceleration and turning is supplied by UAV 82.

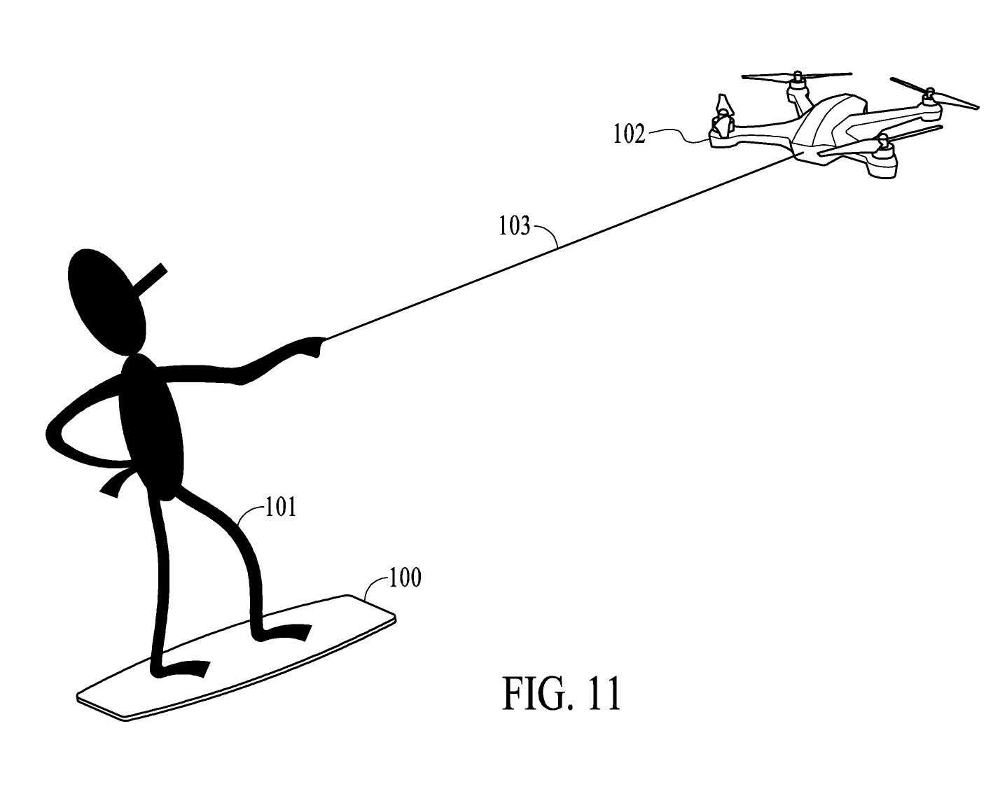

FIG. 10 shows skis 90 adapted to be used with a UAV 93. A cable 93 is composed of, for example, rope, chain, wire cable or some other type of cable. For example, cable 93 is two to six feet long and is connected via a hook to UAV 92.

UAV 92 provides power to transport a skier 91 on skis 90. A control device within skis 90 monitors weight shift of skier 91 on skis 90 to provide control signals to UAV 92. The control device provides UAV 92 with control information pertaining to acceleration, deceleration, left turn and right turn. The control information is provided wirelessly to UAV 92, for example, using the Bluetooth protocol, a WiFi protocol or some other wireless protocol.

Skier 91 leans backward and forward on skis 90 to send control signals to UAV 92 to accelerate and decelerate. Skier 91 leans left and right on skis 90 to send control signals to UAV 92 to veer left and veer right.

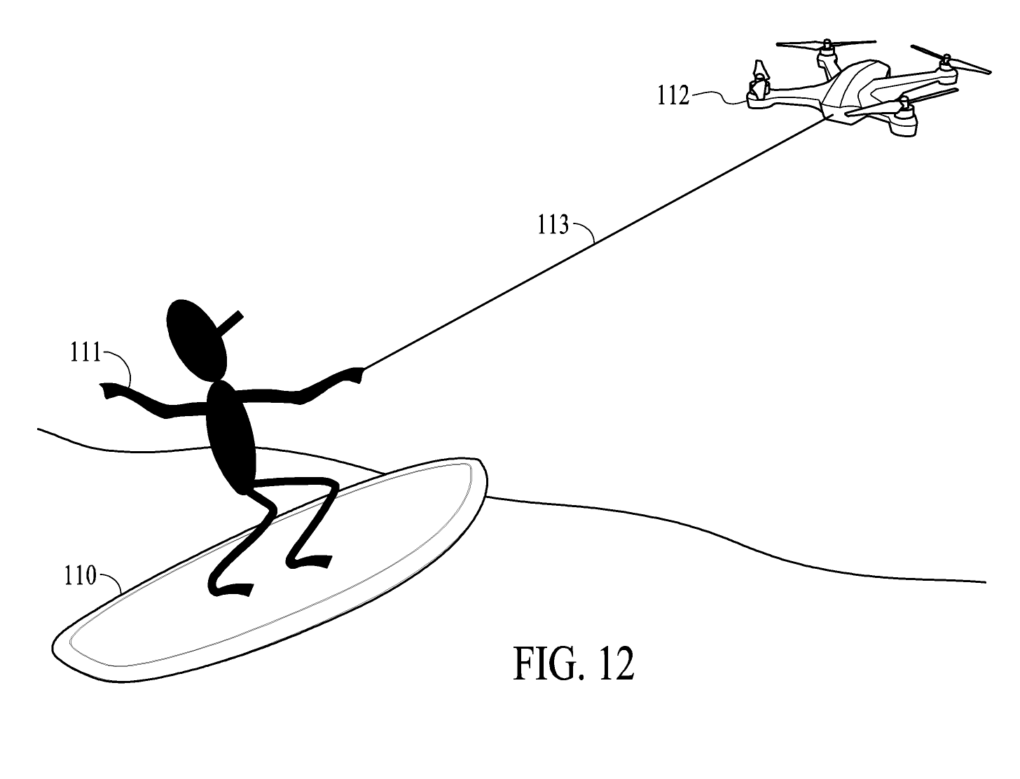

FIG. 11 shows a wakeboard 100 adapted to be used with a UAV 102. A cable 103 is composed of, for example, rope, chain, wire cable or some other type of cable. For example, cable 103 is two to six feet long and is connected via a hook to UAV 102.

UAV 102 provides power to transport a wakeboarder 101 on wakeboard 100. A control device within wakeboard 100 monitors weight shift of rider 101 on wakeboard 100 to provide control signals to UAV 102. The control device provides UAV 102 with control information pertaining to acceleration, deceleration, left turn and right turn. The control information is provided wirelessly to UAV 102, for example, using the Bluetooth protocol, a WiFi protocol or some other wireless protocol.

Wakeboarder 101 leans backward and forward on wakeboard 100 to send control signals to UAV 102 to accelerate and decelerate. Wakeboarder 101 leans left and right on wakeboard 100 to send control signals to UAV 102 to veer left and veer right.

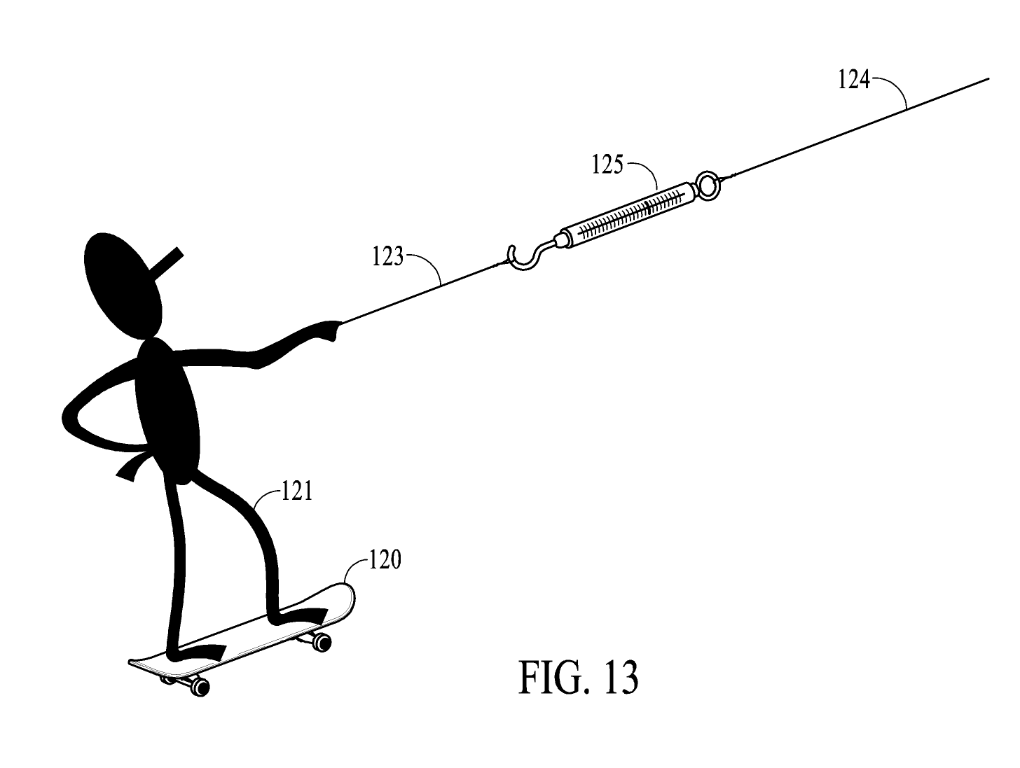

FIG. 12 shows a surf board 110 adapted to be used with a UAV 112. A cable 113 is composed of, for example, rope, chain, wire cable or some other type of cable. For example, cable 113 is two to six feet long and is connected via a hook to UAV 112.

UAV 112 provides power to transport a surfer 111 on surf board 110. A control device within surf board 110 monitors weight shift of rider 111 on surf board 110 to provide control signals to UAV 112. The control device provides UAV 112 with control information pertaining to acceleration, deceleration, left turn and right turn. The control information is provided wirelessly to UAV 112, for example, using the Bluetooth protocol, a WiFi protocol or some other wireless protocol.

Surfer 111 leans backward and forward on surf board 110 to send control signals to UAV 112 to accelerate and decelerate. Surfer 111 leans left and right on surf board 110 to send control signals to UAV 112 to veer left and veer right.

Similarly, a snowboard, roller skates, ice skates, water skis or other type of transportation tool can be adapted to be powered by a UAV. The power required by the UAV varies greatly on the type of transportation tool. For transportation tools used on water, a lot of power may be needed to overcome the friction of water in order to provide a desired speed of travel. For transportation devices used to pull a rider uphill, power will need to be generated to overcome the force of gravity

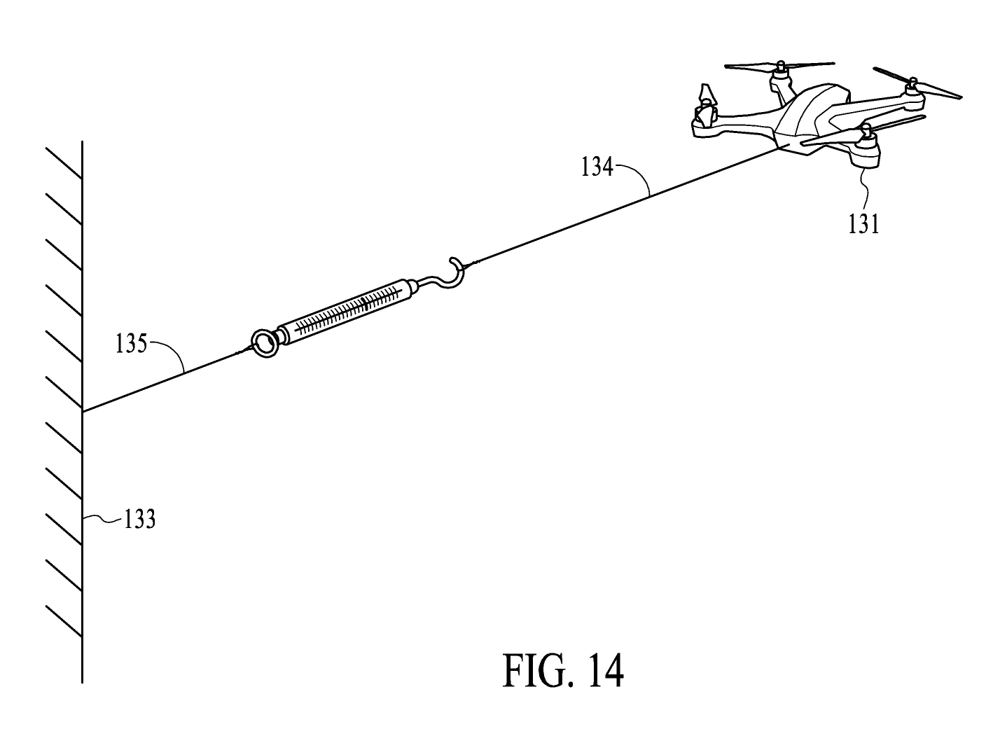

FIG. 13 and FIG. 14 illustrate using a pulling force test to set-up and calibrate UAV powered transportation device in accordance with an implementation.

FIG. 13 shows a rider 121 standing on a transportation tool 120. The transportation tool can be any of the transportation tools discussed above including a skateboard, a hoverboard, skis, a snowboard, skates, a wakeboard, water skis, a surf board and so on. The amount of pull required by a UAV will depend on the transportation tool selected.

The pull force required to move the rider 121 on the transportation tool is estimated. The estimated pull force required takes into account the weight of the rider and the transportation tool, drag created by the transportation tool on the surface, pull force height and so on. For example, the drag created by a skateboard on a road will be influenced by the circumference of the wheels, the quality of the ball bearings and the smoothness of the road. The drag created by skis will be influenced by the friction between the skis and the snow and the slope to be traveled. And so on.

For example, for a skateboard to be used on a flat smooth surface, a rough estimate of pull force required might be calculated using the formula: F=c×W×9.2 meters/secondŝ2; where F is the rolling friction in Newtons; c is the coefficient for different road conditions and W is the weight in kilograms of the rider plus the skateboard. For example, if W is set equal to 80 Kilograms and c is set at 0.015 (rough estimate for a cement surface), the estimated required force (F) is 11.04 Newtons.

This can be verified, for example, using a spring scale as illustrated in FIG. 13 where a spring scale 125 (or an electronic scale) is attached to a cable 123 held by rider 121 and is attached to a cable 124 pulled by another person, animal or motorized vehicle. For example, using this set-up, cable 124 can be used to pull rider 121 on transportation tool 120 at various speeds while monitoring values on spring scale 125 to determine what type of force is required at what speeds. A margin of additional force can then be added to determine a force required by a selected UAV for the application. This margin of additional force may be, for example, three times the force required to pull rider 121 on transportation device 120 at a speed of 0.1 miles per hour.

A UAV is then selected that is able to provide the required force. Depending on the application and design of the UAV, the UAV may have one or multiple rotors. Many UAV manufacturers provide a thrust force specification and specification testing services. This can be used in the selection process.

Testing and verifying force that can be generated by a UAV is also recommended. This can be performed, for example, by the set-up shown in FIG. 14. One end of a spring (or electronic) scale 132 is attached to a UAV 131 via a cord 134. A second end of spring scale 132 is attached via a cord 135 to a stationary object 133 such as a wall or another anchored object. UAV 131 is flown and used to pull against stationary object 133 while values on spring scale 132 are read. For example, five to ten readings of spring scale 132 might be made as the control of UAV 131 is gradually increased in order to record a range of force that can be generated by UAV 131.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. A transportation device comprising:
an unmanned aerial vehicle;
a transportation tool configured to carry a rider, the transportation tool including:
a sensor that detects weight shifts of the rider on the transportation tool,
a controller that based on information from the sensor generates control signals for the unmanned aerial vehicle, and
a communication device that communicates the control signals to the unmanned aerial vehicle; and
a cable attached to the aerial vehicle and to the rider or the transportation tool.

2. A transportation device as in claim 1 wherein the cable is attached to the rider by the rider holding onto a handle that is part of the cable.

3. A transportation device as in claim 1 where the transportation tool is one of the following:
skateboard;
skates;
snow skis;
snowboard;
hoverboard;
wakeboard;
water skis;
surf board.

4. A transportation device as in claim 1 wherein the communication device is a wireless transmitter.

5. A transportation device as in claim 1 wherein the control signals include at least one of the following:
an acceleration command;
a deceleration command;
a veer right command;
a veer left command.

6. A transportation device as in claim 1 wherein when the sensor detects the rider is no longer on the transportation tool, the control signals signal the unmanned aerial vehicle to hover.

7. A transportation device as in claim 1 wherein when unmanned aerial vehicle includes a camera used to monitor the rider.

8. A method to power a transportation tool comprising:
using an unmanned aerial vehicle to pull a rider on the transportation tool;
detecting weight shifts of the rider on the transportation tool;
generating control signals for an unmanned aerial vehicle based on information from the sensor; and,
communicating the control signals to the unmanned aerial vehicle.

9. A method as in claim 8 wherein using the unmanned aerial vehicle to pull the rider includes:
attaching a cable to unmanned aerial vehicle, the cable including a handle to be held by the rider.

10. A method as in claim 8 wherein using the unmanned aerial vehicle to pull the rider includes:
attaching a cable to unmanned aerial vehicle and to either the rider or the transportation tool.

11. A method as in claim 8 wherein the transportation tool is one of the following:
skateboard;
skates;
snow skis;
snowboard;
hoverboard;
wakeboard;
water skis;
surf board.

12. A method as in claim 8 wherein communicating the control signals to the unmanned aerial vehicle is performed by wireless communication.

13. A method as in claim 8 wherein generating the control signals for the unmanned aerial vehicle includes generating the following control signals:
an acceleration command;
a deceleration command;
a veer right command;
a veer left command.

14. A method as in claim 8 wherein generating control signals for the unmanned aerial vehicle includes generating a control signal that signals the unmanned aerial vehicle to hover.

15. A transportation tool, comprising:
a body of the transportation tool configured to carry a rider;
a control device mounted on the body of the transportation tool, control device including:
a sensor that detects weight shifts of the rider on the body of the transportation tool,
a controller that based on information from the sensor generates control signals for an unmanned aerial vehicle, and
a communication device that communicates the control signals to the unmanned aerial vehicle; and
a cable for attaching to the aerial vehicle and to the rider or the body of the transportation tool.

16. A transportation tool as in claim 15 where the transportation tool is one of the following:
skateboard;
skates;
snow skis;
snowboard;
hoverboard;
wakeboard;
water skis;
surf board.

17. A transportation tool as in claim 15 wherein the communication device is a wireless transmitter.

18. A transportation tool as in claim 15 wherein the control signals include at least one of the following:
an acceleration command;
a deceleration command;
a veer right command;
a veer left command.

19. A transportation tool as in claim 15 wherein when the sensor detects the rider is no longer on the transportation tool, the control signals signal the unmanned aerial vehicle to hover.

20. A transportation tool as in claim 15 wherein when unmanned aerial vehicle includes a camera used to monitor the rider.
